(19) United States
(12) Patent Application Publication
(10) Pub. No.: US 2020/0065761 A1
(43) Pub. Date: Feb. 27, 2020

(54) SYSTEM AND METHOD FOR PROVISION OF SUPPLY CHAIN FINANCING OF ETHICALLY VERIFIED PRODUCT WHERE THERE HAS BEEN VERIFICATION OF PRODUCTION PROCESSES AND PRODUCTS INSPECTION USING BLOCKCHAIN SMART CONTRACTS

(71) Applicant: Shona TATCHELL, Ightham (GB)

(72) Inventor: Shona TATCHELL, Ightham (GB)

(21) Appl. No.: 16/561,239

(22) Filed: Sep. 5, 2019

Related U.S. Application Data
(63) Continuation-in-part of application No. PCT/IB2018/051399, filed on Mar. 5, 2018.
(60) Provisional application No. 62/467,164, filed on Mar. 5, 2017.

(51) Int. Cl. G06Q 10/08; G06Q 20/38; G06Q 20/06; G06Q 30/00; G06F 16/23

(52) U.S. Cl. CPC G06Q 10/0875; G06Q 20/389; G06Q 20/3825; G06Q 10/0838; G06Q 2220/00; G06Q 10/0833; G06Q 20/0655; G06Q 30/018; G06F 16/2315; G06Q 10/0835

(57) ABSTRACT

A system and method for ethical product certification related to production process and products inspection using blockchain smart contracts. One embodiment of the system is that an e-cash as a reward is transacted from the buyer to the supplier if the produced product complies with production and/or any other ethical rules and the pricing at which the financing is given is determined by the credit rating of the buyer and a mathematical formula that determines the supplier rating according to the rules of ethical compliance of suppliers.

### CROSS REFERENCED TO RELATED APPLICATIONS

This application is a continuation-in-part (CIP) of PCT/IB2018/051399 filed Mar. 5, 2018 which claims priority to U.S. Provisional Patent Application No. 62/467,164 filed Mar. 5, 2017. The content of the above applications are incorporated by reference in their entirety.

### FIELD OF THE INVENTION

The present invention relates in general to provision of financing of inventory and more particularly, the present invention relates to methods and apparatus for ascertaining ethical product provenance through inspection and certificate validation using blockchain smart contracts and scoring of the relative ethical standards in the supply chain.

### BACKGROUND OF THE INVENTION

Inventory authentication, ethical product certification of production processes, is known in the art.

US Patent Application, 0098723 A1, Systems and Methods for BLOCKCHAIN Verification of Goods, by Feeney, discloses a method for blockchain verification of goods includes creation of a digital identity of products registered in a blockchain, through scanning by a device, using a code scanner, an address from a code affixed to a product, verifying, by the device, that the address is associated with a crypto-currency transaction recorded at a transaction register, obtaining, by the device, at least one current transaction datum, and determining, based on the verification and at least one current transaction datum, that the product is authentic.

There is a long felt unmet need for facilitating the financing of supply chains which genuinely and ascertainably comply with ethical trade practices.

### SUMMARY OF THE INVENTION

In one aspect of the invention is provided a method for ethical certification of production processes where inspection is confirmed using blockchain smart contract and ethical standards scored according to predetermined criteria where the providing of financing is subjected to the ethical provenance, delivery, and/or production of the goods being proven and visible in a ledger.

Ethical trade and Fairtrade have distinct origins, but their approaches are complementary: both focus on helping make international trade work better for poor and otherwise disadvantaged people and for the environment

The ethical trade movement originated in the 1990s when campaigns and media exposés brought attention to potential environmental misdemeanors and the harsh conditions of workers producing clothes, shoes, toys, food and other consumables for multinational companies. Ethical trade involves retailers and brands taking a series of recognized steps to improve the conditions of the workers throughout their supply chains and the environmental conditions of production, wherever they are in the world.

The Fairtrade movement originated in the 1980s to protect poor developing country farmers from low international market prices of commodities such as coffee, cocoa and tea. Products carrying the FAIRTRADE Mark help address the injustice of low prices by guaranteeing that producers receive fair terms of trade and fair prices—whatever the conventional market is. Producer organizations also receive a small premium for business or social development projects.

Along the years, ethical trade was also tied with counterfeiting. As such, according to the Counterfeiting Intelligence Bureau (CIB) of the International Chamber of Commerce (ICC), counterfeit goods make up 5 to 7% of world trade. A report by the Organization for Economic Co-operation and Development (OECD) states that up to $200 billion of international trade could have been for counterfeit and pirated goods in 2005, and around $250 billion in 2007. Other estimates conclude that a more accurate figure is closer to $600 billion lost, since the OECD estimates do not include online sales or goods counterfeited and sold within the same country. The United States faces the most economic impact, as the world's largest consumer nation. The counterfeiting industry is lucrative, and the risks of legal consequences are low. In addition, counterfeiting profits fund other organized criminal activities.

Currently existent anti-counterfeiting measures such as seals of production authenticity, micro-printing, holographs, watermarks, human-invisible inks, encrypted micro particles, and tamper-evident packaging can make counterfeiting more difficult, but largely have failed to hamper the counterfeiting industry. Most of these countermeasures may themselves be counterfeited by more or less sophisticated methods. Moreover, frequently the more difficult a technology is for a counterfeiter to spoof, the more costly the technology is to implement. Thus, even when countermeasures succeed in thwarting counterfeiters, the counterfeiters exact an indirect economic toll on honest merchants and manufacturers.

In view of the above, there is a need for an accurate, cost-effective, and robust anti-counterfeiting inventory production and process inspection system that complies with ethical rules. In other words, the invention provides an automatic process related to the financing of product where the provenance of the product is proven to be ethical, turning it to a more advantageous financing by providing an incentive financing to producers where the financing rate is determined by the ethical rating of the suppliers.

In another aspect of the invention there is provided system and method for multi-party, multi-tier contracts which include all parties and enable the automated distribution of proceeds to each seller from a single payment obligation of an end buyer at the top of a supply chain. The invention provides the end buyer with assurance that the proceeds of the invoice they are settling will flow fairly and transparently back through the supply chain. The invention enables sellers to receive immediate settlement of their receivables subject to their own responsibility towards contract conditions being fulfilled.

It is therefore and object of the invention to provide a computer-based system implementing a smart contract for ordering and invoicing among a plurality of entities comprising an end buyer, suppliers in a supply chain, and a financier—with a single virtual purchase order (VPO) and a single virtual invoice (VI), the system comprising
a. a central server comprising a processor and non-transitory computer readable medium (CRM);
b. client computers comprising computers of an end buyer, of one or more suppliers in a supply chain, and of a financier; the client computers in communicative connection with the central server;
c. the system is configured to store in the
   i. instructions to the processor; and
   ii. a contract database configured to store one or more contract blockchains; each blockchain implementing a smart contract of the supply chain;
d. the instructions cause the processor to
   i. receive a VPO with a digital signature, issued by the end buyer computer, for finished goods in exchange for an end-buyer price;
   ii. create a contract blockchain in the contract database;
   iii. append the VPO 440 to the contract blockchain;
   iv. append terms-of-contract to the VPO, the terms-of-contract comprising the end-buyer price, fulfillment requirements for each of the suppliers, and proportions of the end-buyer price accruing to each of the suppliers;
   v. receive VPO approvals with digital signatures from the supplier computers;
   vi. append the VPO approvals to the VPO;
   vii. appending a VI to the contract blockchain;
   viii. receive a statement of fulfillment with digital signature from each of the supplier computers upon fulfillment of the terms-of-contract by each the supplier;
   ix. append the statement of fulfillment to the VI, for each of the suppliers;
   x. receive a statement of payout to each the supplier according to the proportion, from the financier computer;
   xi. append each the statement of payout to the VI;
   xii. receive a delivery confirmation upon delivery of the finished goods to the end buyer or fulfillment of the terms of said-terms of-contract between buyer and seller 560;
   xiii. append the delivery confirmation to the VI;
   xiv. reconcile the terms-of-contract in the VPO with the fulfillment statements in the VI;
   xv. append a reconciliation statement to the VI;
   xvi. receive an end-buyer payment confirmation from the financier computer, upon payment of the end-buyer price by the end buyer; and
   xvii. append the end-buyer payment confirmation to the contract blockchain;
wherein the system is configured to synchronize a copy of the contract blockchain on each the suppliers' computers after each the step of appending to the contract blockchain; an updated copy of the VPO and the VI are thereby visible on displays of the suppliers' computers.

It is a further object of the invention to provide the abovementioned system, wherein the processor is further configured to calculate the end-buyer price and/or the proportions to each supplier as a function of one or more scores of one or more of the parties in the supply chain.

It is a further object of the invention to provide the abovementioned system, wherein the statement of fulfillment for each supplier is issued from a client computer of a supplier that is next-lowest to the supplier in the supply chain.

It is a further object of the invention to provide the abovementioned system, wherein the instructions are further configured to cause the processor to receive one or more supplier certifications 465 from one or more of the supplier computers 420b-c and to append the supplier certifications 465 to the VPO.

It is a further object of the invention to provide the abovementioned system, wherein the supplier certifications are in a group consisting of a certification of land ownership, a certification of labor laws compliance, a certification of environmental standards compliance, a product certification, an ISO certification, a certification of insurance, a certification of inspection, and any combination thereof.

It is a further object of the invention to provide the abovementioned system, wherein the instructions are further configured to cause the processor to receive confirmations of the supplier certifications from a computer of one or more certifying authorities and to append the certification confirmations to the contract blockchain.

It is a further object of the invention to provide the abovementioned system, wherein the wherein the instructions are further configured to cause the processor to receive one or more transit status reports and to append the transit status reports to the VI.

It is a further object of the invention to provide the abovementioned system, wherein the transit status reports are issued by a client computer of an entity in a group comprising a shipping company, a customs authority, an inspection agency, a warehouse, a freight forwarder, any other transport provider (such as an airline, a road or rail transport provider), a third party verifier of goods delivery or contract fulfillment, or any combination thereof.

It is a further object of the invention to provide the abovementioned system, wherein the contract blockchain 435 is accessible by computer of the buyer 420a, of the financier 420d, of the certifying authority 420e, or any combination thereof.

It is a further object of the invention to provide a computer-based method 500 of a smart contract for ordering and invoicing of a plurality of parties with a single virtual purchase order (VPO) and a single virtual invoice (VI), the method comprising steps of
a. providing the computer-based system for implementing a smart contract as set forth in the claims;
b. receiving, by a central server, a VPO with a digital signature, issued by an end buyer in a supply chain, for finished goods in exchange for an end-buyer price 505;
c. creating a contract blockchain in a non-transitory computer readable medium (CRM) of the central server 510;
d. appending the VPO to the contract blockchain 515;
e. appending terms-of-contract to the VPO, the terms-of-contract comprising the end-buyer price, fulfillment requirements for each supplier in the supply chain, and proportions of the end-buyer price accruing to each of the suppliers 520;
f. receiving VPO approvals with digital signatures from the suppliers 525;
g. appending the VPO approvals to the VPO 530;
h. appending a VI to the contract blockchain 535;
i. receiving a statement of fulfillment for each of the suppliers upon fulfillment of the terms-of-contract by the supplier 540;
j. appending each the statement of fulfillment to the VI 545;
k. receiving a statement of payout, to each the supplier according to the proportion, from a financier upon each the statement of fulfillment 550;
l. appending each the receipt of payout to the VI 555;
m. receiving a delivery confirmation upon delivery of the finished goods to the end buyer or fulfillment of the terms of said-terms of-contract between buyer and seller 560;
n. appending the delivery confirmation to the VI 565;
o. reconciling the terms-of-contract in VPO with the fulfillment statements in VI 567;
p. appending a reconciliation statement to the VI 568;
q. receiving an end-buyer payment receipt from the financier, upon payment of the end-buyer price by the end buyer 570; and
r. appending the end-buyer payment receipt to the VI 575;
   wherein the method further comprises steps of synchronizing copies of the contract blockchain on the suppliers' computers 580 and repeating the step of synchronizing after each the step of appending to the blockchain 585; an updated copy of the VPO 440 and the VI 445 are thereby visible in on displays 422b-c of the suppliers' computers 420b-c.

It is a further object of the invention to provide the abovementioned method, further comprising a step of calculating the end-buyer price and/or the proportions to each supplier as a function of one or more scores of one or more of the parties in the supply chain.

It is a further object of the invention to provide the abovementioned method, further comprising a step of issuing the statement of fulfillment for each supplier by a supplier computer of a supplier that is next-lowest to the supplier in the supply chain.

It is a further object of the invention to provide the abovementioned method, further comprising steps of receiving one or more supplier certifications from one or more the supplier computers and appending the supplier certifications to the VPO.

It is a further object of the invention to provide the abovementioned method, wherein the supplier certifications are in a group consisting of a certification of land ownership, a certification of environmental standards compliance, a certification of labor laws compliance, a product certification, an ISO certification, a certification of insurance, a certification of inspection, and any combination thereof.

It is a further object of the invention to provide the abovementioned method, further comprising steps of receiving confirmations of the supplier certifications from a computer of one or more certifying authorities and appending the certification confirmations to the contract blockchain.

It is a further object of the invention to provide the abovementioned method, further comprising steps of receiving one or more transit status reports and appending the transit status reports to the VI.

It is a further object of the invention to provide the abovementioned method, wherein the transit status reports are issued by a client computer of an entity in a group comprising a shipping company, a customs authority, an inspection agency, a warehouse, a freight forwarder, any other transport provider (such as an airline, a road or rail transport provider), a third party verifier of goods delivery or contract fulfillment, or any combination thereof.

It is a further object of the invention to provide the abovementioned method, further comprising one or more steps of permitting access to the contract blockchain by the buyer, the financier, the certifying authority, or any combination thereof.

It is a further object of the invention to provide a computer implemented method 100 for facilitating financing of goods distributed to a buyer from a supplier, in a network based private or public permissioned blockchain, comprising:
a. creating an instance of an electronic cash for goods blockchain contract 101
b. presenting a blockchain certification for the instance 102
c. validating the blockchain certificate by comparing the certificate's details to the goods' details and predetermined ethical rules compliance 103
d. exposing the goods' details by the certificate's details 104
e. confirming an invoice, purchase order (PO) and goods received notes (GRN) and details according to the goods blockchain contract 105
f. determining rewarding extent threshold according to the ethical rules compliance 106
g. transferring the rewarding extent money as e-cash from the buyer to the supplier 107
h. sending e-docs to the buyer related to the goods blockchain contract's details 108
i. delivering the goods to the buyer 109
   wherein the goods blockchain contract's details are displayed on a computer interface by a displaying module

It is a further object of the invention to provide the abovementioned method, wherein the providing a blockchain certification, is managed by an execution of a registration module configured to:
a. receive a request from a potential buyer to register with the certificate associated to blockchain certification
b. providing a created blockchain certification to the buyer
c. notifying the buyer upon creation of new blockchain certification

It is a further object of the invention to provide the abovementioned method, wherein the validating the blockchain certificate, is managed by an execution of a comparison module.

It is a further object of the invention to provide the abovementioned method, wherein the certificate's details comprise any of the following attributes: geo-tagging location of the goods, time and date of transportation of the goods, third party confirmation of fulfillment of contract terms, ethical details related to compliance of ethical rules and any combination thereof.

It is a further object of the invention to provide the abovementioned method, wherein the ethical rules are stored as files in a database.

It is a further object of the invention to provide the abovementioned method, wherein the comparison module is configured to:
a. select invoices from a group associated with the goods blockchain contract's details;
b. compare a plurality of tags's records with the stored records in the database related to each the goods blockchain resulting in a satisfied or un satisfied output and determining the supplier's ethical rating (which in turn will determine the price of the financing); and
c. displaying the output in the interface.

It is a further object of the invention to provide the abovementioned method, wherein the tags' records comprise a plurality of records such as: invoice, purchase order (PO), the goods received notes (GRN), or confirmation of contract fulfillment.

It is a further object of the invention to provide the abovementioned method, wherein the confirming of the invoice, purchase order and goods received notes is managed by an execution of a confirmation module configured to:
d. receive a request from a potential buyer to register with the certificate;
e. compare the certificate's details with the invoice, the PO and the GRN resulting in a match vector comprising 3 attributes: a first match ranges from 0% to 100% representing a match between the certificate's details and details of the invoice in the contract details, a second match ranges from 0% to 100% representing a match between the certificate's details and details of the PO in the contract details, and a third match ranges from 0% to 100% representing a match between the certificate's details and details of the GRN in the contract details; and
f. displaying the matched vector on buyer's interface.

It is a further object of the invention to provide the abovementioned method, wherein the determining rewarding extent threshold according to the ethical rules compliance is managed by an execution of determination module configured to:
g. extract the first matched attribute and the second matched attribute from the match vector; and
h. transform the first match and the second match into a unified sum of the match and the second match by means of e-cash reward value.

It is a further object of the invention to provide the abovementioned method, wherein the transferring the rewarding extent money as e-cash to supplier is conducted by an execution of e-cash transaction module configured to:
a. communicate with supplier's bank account through buyer's device;
b. transmit the e-cash reward to the supplier's bank account; and
c. notify the supplier upon e-cash transmission on the supplier's device's interface.

It is a further object of the invention to provide the abovementioned method, wherein the sending e-docs to buyer is conducted by an execution of a sending module configured to:
a. create e-docs consisting the certificate's details;
b. communicate with buyer's interface;
c. transmit the e-docs to the buyer's storage; and
d. notify the buyer upon transmission on the buyer's interface.

It is a further object of the invention to provide the abovementioned method, wherein the delivering goods to the buyer is managed by a selection of one or more delivery transportation vehicle comprising: land, sea, and air transportation vehicle; or through third party confirmation of fulfillment of contract terms.

It is a further object of the invention to provide a blockchain system for certification of products distributed to a buyer, in a network based private blockchain, comprising:
a. a first computing device interconnected to a database used to store details related to the products
b. a certificate reader
c. a certificate interconnected to the product
d. a second computing device used to receive details from the certificate the products scanned by the certificate reader
e. an operations module used to execute operations on the blockchain associated with the first computing device by an execution module to verify that the product complies to production and or any other ethical rules
   wherein supplier is rewarded by an e-cash transaction from the buyer according to an execution result received by an execution of rewarding module associated with the operation module that activates a certification operation module associated with the operations module in order to verify the authentication of the product and or the compliance to ethical rules

It is a further object of the invention to provide the abovementioned system, wherein the first computing device may be incorporated in a production-inventory tracking system

It is a further object of the invention to provide the abovementioned system, wherein the second computing device may be incorporated in a production-inventory tracking system.

It is a further object of the invention to provide a computerized decision support method for automatically financing and processing trade transactions between suppliers and buyers through blockchain smart contracts comprising:
a. enabling inspection agencies to digitally record inspections of data at source throughout the production cycle;
b. validating the inspected data against the certification recorded in the blockchain;
c. transmitting a data enriched certificate to the supply chain finance provider;
d. triggering a blockchain smart contract;
e. determining rewards at the sight of smart contracts;
f. releasing funding to the supplier in the form of the reward for the agreed credit term of the supply contract;
g. receiving an invoice, immediately available and visible to the buyer, seller and financier alike or only to those with permission to view;
h. confirming and exposing product ID to the buyers; and
i. issuing a purchase order (PO) and a goods receive note (GRN) by the potential buyers through smart contracts.

It is a further object of the invention to provide the abovementioned method, wherein digital inspection records are stored through distributed ledger (blockchain) by an execution of a module configured to
a. enabling inspection agencies to digitally record inspections at source throughout the production cycle;
b. the distributed ledger (blockchain) holds the time, date and location stamp for the certification status; and
c. the provenance of the product is validated against the certification recorded in the blockchain.

It is a further object of the invention to provide the abovementioned method, wherein the blockchain technology combined with digital geo-tagging confirms traceability of the product and transparency of the ethical provenance.

It is a further object of the invention to provide the abovementioned method, wherein the method includes steps of configuring the mobile app to record location, time and date stamps to create a digital fingerprint for the asset through a scan containing key attributes.

It is a further object of the invention to provide the abovementioned method, wherein supplier's compliance is cross-checked against various separate audit databases confirming whether there is the valid audit in place.

It is a further object of the invention to provide the abovementioned method, wherein the smart contract held in the blockchain with final data enriched certificate.

It is a further object of the invention to provide the abovementioned method, wherein the smart contract will immediately be transmitted to the supply chain finance provider comprising:
a. computing a relative ethical score of the supplier in accordance with compliance by the supplier with ethical production practices;
b. triggering and releasing funding to the supplier in the form of a loan or prepayment of the invoice for the agreed credit term of the supply contract and a reward;
c. rewarding the supplier in accordance with the relative ethical score; and
d. optionally financing at a rate according to the risk of the buyer rather than the supplier.

It is a further object of the invention to provide the abovementioned method, wherein the smart contract recorded in the multi user network comprises invoice, purchase order (PO), goods received notes (GRN), confirmation of contract fulfillment, etc.

It is a further object of the invention to provide the abovementioned method, wherein the invoice conveys to the potential buyer or those with permission to view through proper registration comprising:
a. providing smart certificate to the potential buyers to review, revise, negotiate and accept; and
b. notifying any modification to buyers, suppliers and financier by creating the new blockchains.

It is a further object of the invention to provide the abovementioned method, wherein the delivering goods to the buyer is managed by a selection of one or more delivery transportation vehicle comprising: land, sea, and air transportation vehicle; or through third party confirmation of fulfillment of contract terms.

It is a further object of the invention to provide a blockchain system for certification of products distributed to a buyer, in a network based private blockchain, comprising:
a. a first computing device interconnected to a database used to store details related to the products
b. a certificate reader
c. a certificate interconnected to the product
d. a second computing device used to receive details from the certificate the products scanned by the certificate reader
e. an operations module used to execute operations on the blockchain associated with the first computing device by an execution module to verify that the product complies to production and or any other ethical rules
   wherein supplier is rewarded by an e-cash transaction from the buyer according to an execution result received by an execution of rewarding module associated with the operation module that activates a certification operation module associated with the operations module in order to verify the authentication of the product and or the compliance to ethical rules

It is a further object of the invention to provide the abovementioned system, wherein the first computing device may be incorporated in a production-inventory tracking system.

It is a further object of the invention to provide the abovementioned system, wherein the second computing device may be incorporated in a production-inventory tracking system.

It is a further object of the invention to provide the abovementioned system, wherein the buyer will receive e-docs and takes up goods immediately.

It is a further object of the invention to provide a method for redistributing finance savings of a decentralized supply chain, comprising steps of
a. confirming consensus of agreed terms between parties, resulting in matched smart contract specifications;
b. writing and deploying one or more smart contracts, configured to autonomously govern the supply chain and redistribution of the finance savings, in accordance with the matched specifications;
c. supplying data of purchase orders via oracles, the purchase order data immutably matched by the smart contracts;
d. confirming contract fulfillment of the terms by sellers, the fulfillment immutably recorded in the smart contracts;
e. confirming approval of invoices and immutably recording the invoice approval confirmations in the smart contracts;
   wherein the method further comprises steps of
f. initiating and confirming availability of the supply chain financing facility, immutably recording data related to confirmation of invoice discounting;
g. quantifying the finance savings to be accrued by the supplier from the use of the supply chain financing facility, the quantification immutably recorded in the smart contracts; and
h. facilitating and confirming the finance savings redistribution.

It is a further object of the invention to provide a system for redistributing finance savings of a decentralized supply chain (DSCFS), comprising
a. a DSCFS server, configured to execute a decentralized supply chain finance savings algorithm (DSCFS-A);
b. a buyer interface, configured for buyer entry and sending to the DSCFS server of buyer contract terms, a purchase order, and contract fulfillment conditions;
c. a seller interface, configured for receiving the purchase order from the DSCFS server and for seller acceptance of the purchase order and for entry and sending to the DSCFS server of seller contract terms and an invoice;
d. a buyer financier interface, configured for buyer financier entry and sending to the DSCFS server of buyer financier contract terms, buyer risk margin, buyer interest rate, and invoice discount data;
e. a seller financier interface, configured for seller financier entry and sending to the DSCFS server of seller financier contract terms, seller risk margin, and seller interest rate;
f. a distributed-ledger network, configured for immutably recording transactions of smart contracts;
   the DSCFS server is further configured to
g. confirm consensus of agreed terms between the parties, resulting in matched smart contract specifications in the;
h. write and deploy one or more smart contracts, immutably recorded in the distributed-ledger network; the smart contracts configured to autonomously govern the supply chain and redistribution of the finance savings, in accordance with the matched specifications;
i. supply data of purchase orders via oracles, the purchase order data immutably matched in the distributed-ledger network;
j. confirm contract fulfillment of the terms by sellers, the fulfillment immutably recorded in the distributed-ledger network;
k. confirm approval of invoices and immutably recording the invoice approval confirmations in the distributed-ledger network;
   wherein the DSCFS server is further configured to
l. initiate and confirm availability of the supply chain financing facility, immutably recording data related to confirmation of invoice discounting in the distributed-ledger network; and
m. quantify the finance savings to be accrued by the supplier from the use of the supply chain financing facility, the quantification immutably recorded in the distributed-ledger network; and
n. facilitate and confirm the finance savings redistribution, recording the redistribution immutably in the distributed-ledger network.

### Definitions

The term “blockchain” refers to a public ledger that records peer to peer digital transactions such as bitcoin transactions.

The term “public blockchain” refers to a blockchain, in which no restrictions on reading blockchain data (which still may be encrypted) and submitting transactions for inclusion into the blockchain.

The term “private blockchain” refers to a blockchain, in which direct access to blockchain data and submitting transactions is limited to a predefined list of entities.

The term “smart contracts” refers to digital entities that define complex transaction logic and facilitate cross-organizational workflow including, but not limited to, storage of data, data access permissions, ordered workflow and computation.

The term “public key” refers to a cryptographic key used with a public key cryptographic algorithm that is uniquely associated with an entity and that may be made public.

The term “private key” refers to a cryptographic key, used with a public key cryptographic algorithm that is uniquely associated with an entity and is not made public.

The term “multi-signature” (multi-sig) refers to a digital signature scheme that allows a group of users to sign a single document.

The term “fiat currency” refers to a currency which is created by “fiat” or “arbitrary” order or decree of the government. Examples of fiat currencies include, but are not limited to: the US dollar, the euro, the Great Britain pound, the Japanese Yen, etc.

The term “crypto currency” refers to an Internet-based medium of exchange distinct from physical (such as banknotes and coins) that exhibits properties similar to physical currencies, but allows for instantaneous transactions and borderless transfer of ownership. Cryptocurrencies are types of digital currencies. Cryptography is used to secure the transactions and to control the creation of new coins.

The term “ethical rules” refers to ethical production rules, labor practice rules, environmental rules and organic rules during a production process, regulations, and factory and or source details.

The term “ethical production rules” refers to factory and production audits rules, audit certificates related to ethical labor rules, environmental rules and or organic practices.

The term “device”, “terminal”, “computer terminal”, a “server”, interchangeably refers to, but is not limited to hardware such as: a mobile phone, laptop, tablet, wearable computing device, cellular communicating device, PDA, communication device, personal computer, and etc.

The term “Certification” refers to, but is not limited to a product, a company, an organization levels etc.

The term “e-cash” refers to any financial transaction that is transformed by an electronically means such as: software, hardware, or any combination thereof.

The term “source details” refers to any source of agricultural and or extraction of raw materials.

The term “supplier” refers to any participant along the supply chain that supplies a product, such as: manufacturer, distributor, retailer or any person distributing the product along the supply chain to the buyer.

The term “buyer” refers to any participant along the supply chain who buys a product: such as: distributor, retailer.

The term “user” refers to the person or persons employing a system or method of the invention, so authorized by a single party to a smart contract managed thereby.

The term “oracle” refers to an electronic data service that can send and verify real world occurrences and submit this information to smart contracts, triggering state changes in the blockchain.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which:

FIG. 1 shows an example of the flow chart diagram using an embodiment of the invention, presenting a method for product certification of production process and products inspection.

FIG. 2 shows a block diagram of an embodiment of the disclosed system (200), that graphically illustrates the following: upon any registration request from a buyer's device and/or a supplier's point of sale device that communicate with the application, the device creates a new blockchain account with multi-sig pair (one private key on the buyer device (205) and one private key on the supplier device (209).

FIG. 3 shows an example of the flow chart diagram using an embodiment of the invention, presenting a method for digital product certification and products inspection.

FIG. 4a shows a computer-based system for implementation of multi-party, multi-tier (MPMT) contracts, according to some embodiments of the invention.

FIG. 4b shows the structure of contract blockchain stored in contract database, according to some embodiments of the invention.

FIGS. 5a and 5b show a computer-based method for implementation of multi-party, multi-tier (MPMT) contracts, according to some embodiments of the invention.

FIG. 6 shows steps of the DSCFS-A method.

FIG. 7 shows a system 700 for redistributing finance savings of a decentralized supply chain (DSCFS).

### DETAILED DESCRIPTION OF THE INVENTION

The following is a detailed description of the preferred embodiments. Reference is made to the accompanying drawings that form a part hereof, and in which are shown by way of illustration, specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Although the technology will be described in conjunction with various embodiment(s), it will be understood that they are not intended to limit the present technology to these embodiments. To the contrary, the present technology is intended to cover alternatives, modifications and equivalents which may be included within the spirit and scope of the various embodiments as defined by the appended claims.

In the following description of embodiments, numerous specific details are set forth in order to provide a thorough understanding of the present technology. However, the present technology may be practiced without these specific details. In other instances, well known methods, procedures, components, and circuits have not been described in detail so as not to unnecessarily obscure aspects of the present embodiments.

The present invention utilizes a blockchain smart contracts technology to manage details related to the product along the whole supply chain stations. Management is conducted through a predetermined process in which, a verification process, ensures that the smart contract traverses along the supply chain for each product associated with an invoice, where through the process it is verified that each company as part of the supply chain has a pre-determined ethical certificates for both their own activities, and for the specific product(s)

For example, a smart contract related to product details such as: the industry location, time and date related to the shipment of the product, the supplier and or distributor associated details, as well as associated transactions, may be tracked on a private or public permissioned blockchain, where those smart contracts associated with the blockchain may be automatically settled with corresponding payments. The smart contract “Smart product certification redemption” reflects the payment agreement details between the supplier and the buyer such as by lowering the cost at which a supplier may receive earlier settlement of the product resulted from the purchase of the product by a buyer from the supplier or any other participant supplier along the supply chain. The amount of e-cash payment is determined according to the product production and distribution details along the supply chain process and the financing rate for an early settlement may be determined by a logic that attributes ethical rating to that supplier calculated according to a mathematical formula or algorithm. Using a private or public permissioned distributed ledger, multiple parties working together will have an unprecedented view of partnerships commerce. The parties can hide private/sensitive data from each other or comply with buyer's data and supplier's data and privacy laws by hashing or hiding information that is deemed protected. The data dashboard encourages transparency and real-time tracking of what could be considered a “global product certification process”.

A supplier creates a smart contract generating unique electronic cash ID assigned to the product. The ID is distributed to a buyer through a digital transmission. The supplier presents the product to the buyer at buyer's point of sale/e-commerce platform and checks through the blockchain that the certificate associated with the product is valid. If so, then a validation process to evaluate whether the product was produced and or complies with ethical rules is conducted. A reliable, immutable, shared record of transaction activity may be recorded on the distributed ledger so that an accurate view of the smart contract's transaction activity may be tracked. If validation process as well as confirmation related to the invoice, PO and GRN details associated with the product is found as successful, then selected data items in the smart contract may be encrypted and only be visible to intended recipients through a read and write key permissions process. The blockchain event system is used to notify relevant parties of a new blockchain transaction which may be of interest. The invention also supports a multi-sig feature on the blockchain which requires multiple signatures associated with an individual or signatures from multiple signatories in order to interact with the blockchain.

The proposed system generates unique product's details certificate optionally with buyer-identifying data, in which a supplier could get paid in real-time on one hand while the buyer could receive data related the product on the other hand. With this process a supplier could create a global product's authentic track redemption and sales of promoted products in near real-time.

Another aspect of the present invention relates to a system and method for multi-party, multi-tier contracts which include all parties and enable the automated distribution of proceeds to each seller from a single payment obligation of an end buyer at the top of a supply chain. The invention provides the end buyer with assurance that the proceeds of the invoice they are settling will flow fairly and transparently back through the supply chain. The invention enables sellers to receive immediate settlement of their receivables subject to their own responsibility towards contract conditions being fulfilled.

The invention can transform commercial relationships within a supply chain into a circle of trust among all parties, wherein terms are agreed through a blockchain-based consensus mechanism executed through code.

A single virtual purchase order (VPO) and a single virtual invoice (VI) span the entire supply chain, including each supplier tier, and the contract terms (product to be delivered, incoterms, timing price, quality etc.) are visible to all suppliers in the supply chain (pricing and delivery terms may vary but product content and quality will be consistent).

Every party digitally (using cryptography) signs the contract (VPO) and every party—suppliers and end buyer—signs the invoice (VI) using a multisig function.

Each supplier can see the status of the invoice and the fulfillment of the terms of the VPO.

The end buyer is the primary issuer of the VPO that is delivered through the system to the whole supply chain

The VPO and the VI set out the proportion of the value that should accrue to each party as % of the overall contract value

The VI is automatically approved by a central server, utilizing business logic (if x, y, z conditions occur then the VI is automatically approved) as each agreed condition is fulfilled by each party

The encoded agreement also managed through a smart contract between the central server and the end buyer, is that a multisig approval represents a payment obligation by the end buyer to honor payment of the invoice on the due date. This then enables a financier to look to the Ultimate Buyer as the credit-risk (counterparty) for the underlying invoice discounting facility (which enables the advance of funds to sellers). Sellers are able to receive the % of value owed to them under the VI where the discount rate (financing rate for early payment) is determined through the Halo scoring and pricing mechanism.

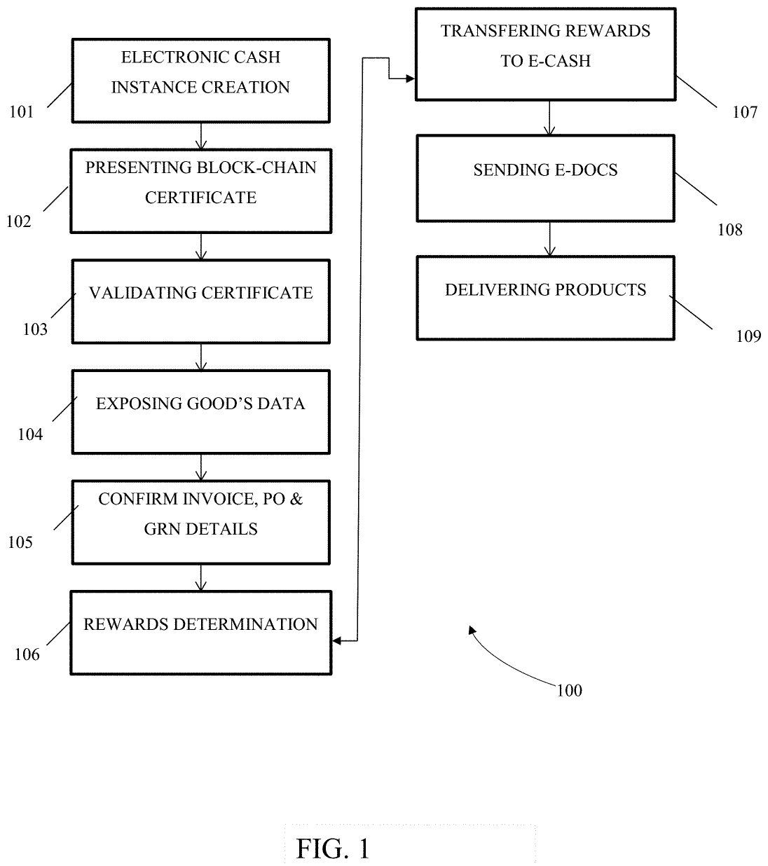

Referring to FIG. 1, FIG. 1 shows an example of the flow chart diagram using an embodiment of the invention, presenting a method for product certification of production process and products inspection. The flow chart is related to a product certification, payment flow, a redemption in e-cash that is transferred to a supplier in case that the product complies to ethical rules. At the end of the process, data related to the product provenance is sent, retrieved or presented to the buyer of the product as part of the process of purchasing the product. The following steps are performed:

### 1. Supplier: Creating an Electronic Cash Instance

The application creates an electronic cash instance (101)

### 2. Supplier: Providing a Blockchain Certificate

The application presents a blockchain certificate certified by an authorized authority, ensures that the produced product holds a certificate that is readable by the application and assigns the blockchain a unique identifier (102)

### 3. Buyer: Certificate Validation and Confirmation

3.1 Supplier presents the certificate embodiment with the product to the buyer at any point along the supply chain.
3.2 The buyer validates at point of sale or at any other point along the supply chain the proposed product with the embodiment certificate (103).
3.3 If certificate is validated successfully, then the data related to the proposed product is exposed to the buyer (104). Next, a confirmation process using the details extracted from the product's certificate related to purchase order (PO) and goods received notes (GRN) is conducted (105)
   4. Supplier: Rewarding of e-Cash
4.1 Supplier application checks confirmation result that the supply rating meets the ethical criteria (the product complies with predetermined ethical production rules), the final product price and delivery criteria, and the smart contract is marked and signed by the supplier, or any other participant along the supply chain.
4.2 Upon successful confirmation process, a new transaction is determined by the buyer in order to be sent to the supplier by using a blockchain (106)
4.3 As a result of the blockchain event mechanism, triggered by the supplier, the application receives a smart contract event and retrieves smart contract produced data while creating a rewarded e-cash from the buyer to the supplier according to their pre-determined contract terms (106).
4.4 Payment details are recorded in a smart contract.
4.5 Bank/payment processor executes payment transfer from the buyer to the supplier either by signing a blockchain smart contract using its own key (possibly with own node) or by exposing an API where cryptographic proof identifying bank/payment processor is provided and stored in a smart contract. Confirmation of payment is sent to buyer and/or to the supplier as part of the transferring process (107).
4.6 Upon bank confirmation of e-cash, the supplier application initiates a new blockchain transaction including the bank confirmation with recipient address as the buyer (as part of the transferring e-cash process) (107) and recorded in the blockchain.
   5. Supplier—Buyer: Sending e-Docs and Delivering Products
5.1 As a result of the blockchain event mechanism, the supplier produces e-docs (108) delivered to the buyer together with the distribution of the product (109).

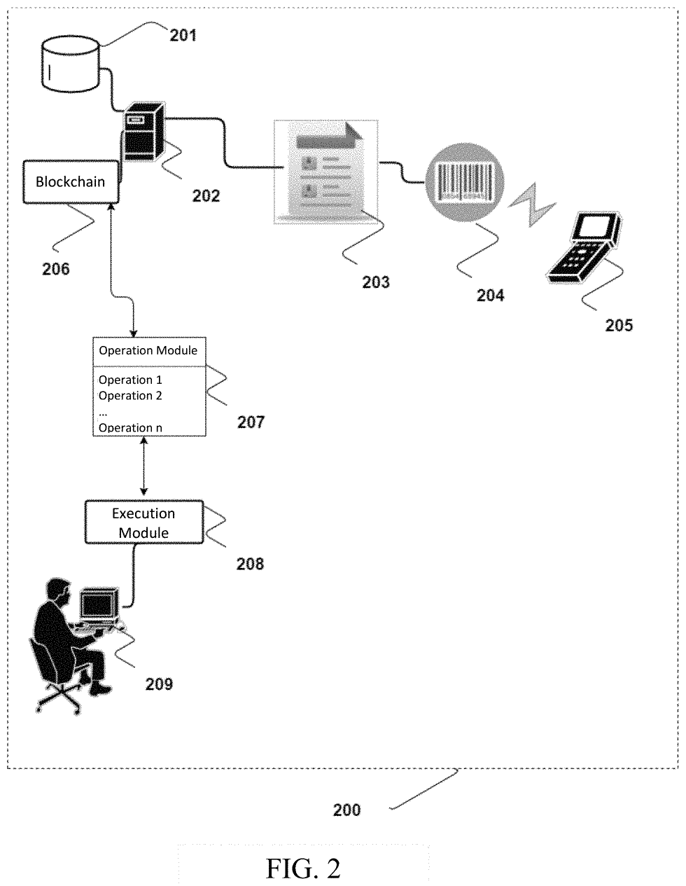

FIG. 2 shows a block diagram of an embodiment of the disclosed system (200), that graphically illustrates the following: upon any registration request from a buyer's device and/or a supplier's point of sale device that communicate with the application, the device creates a new blockchain account with multi-sig pair (one private key on the buyer device (205) and one private key on the supplier device (209). The blockchain is used to deliver product's (203) details from the product's certificate (204) to a buyer's mobile and or point of sale's device (209) or any point of delivery along the supply chain by an execution of set of operations modules such as: validation, confirmation rewarding etc. If the product's details that are extracted by scanning the product's certificate through the usage of a certificate reader (205) reveal that the product was produced and or supplied according to a compliance of ethical production rules, then a reward e-cash process is conducted from the buyer to the supplier that is embodiment in the final purchased product's price presented to the buyer along the supply chain.

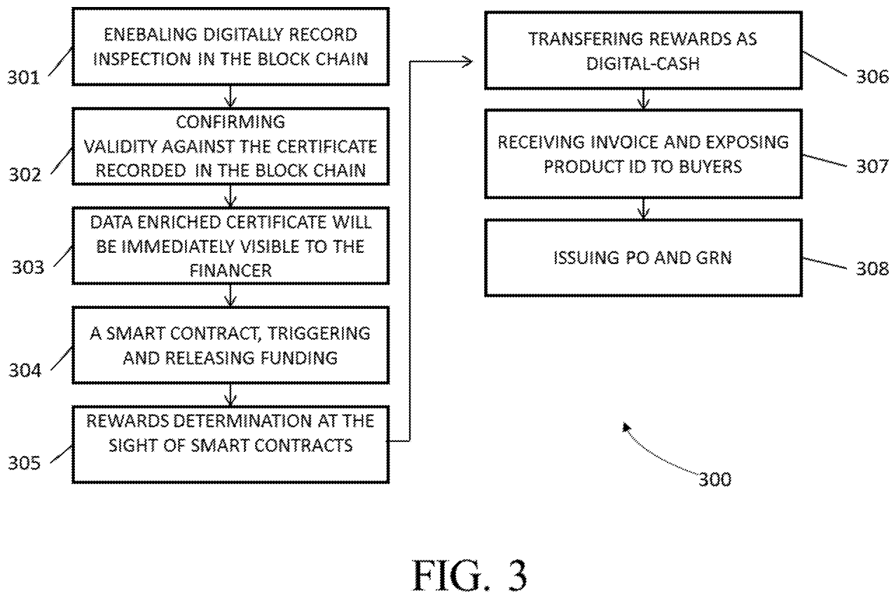

FIG. 3 shows an example of the flow chart diagram using an embodiment of the invention, presenting a method for digital product certification and products inspection. The flow chart is related to a product certification, verification of certificate, smart contracts, financing the suppliers if it complies with ethical rules. At the end of the process, a smart contract related to the product provenance is sent, retrieved or presented to the buyer of the product as part of the process of purchasing the product. The following steps are performed:

1. Supplier: Creating a digital record of certificate
The application enables a digitally record of inspection in the blockchain (301)

### 2. Supplier: Providing a Blockchain Certificate and Validation

The application then cross-checks for the supplier's compliance against various separate audit databases to confirm that there is a valid audit in place. (302)

### 3. Financier: Data Enriched Certificate and Confirmation

The validated data enriched certificate is immediately visible to the financier and confirms traceability of the product and transparency of the ethical provenance. (303)
   4. Financier: SMART CONTRACT and immediate release of funding
A blockchain smart contract will be created and code-enabled invoices that ensure payment is released promptly against this confirmation when pre-determined criteria are satisfied. (304). Payment will either be made at sight, by means of discounting the face value of the invoice (where the discount rate is determined according to the rating applied by the system), or on the due date of the invoice.
   5. Financier: Reward determination
The reward will be determined by a logic that attributes ethical rating to that supplier calculated according to a mathematical formula or algorithm at the sight of the smart contracts. (305)
   6. Financier: transferring reward as digital cash
The fund will be rewarded to the supplier in the form of a loan or advance payment for the agreed ethical credit term of the supply contract. Optionally, this funding will be priced according to the risk of the buyer rather than the supplier. (306)
   7. Buyer: Registering and receiving Invoice
The buyer will get an invoice, issued by the supplier, through proper registration. The buyer can view, examine, suggest and confirm the invoice. The confirmation process takes only minutes and is immediately available and visible to the buyer, seller and financier alike or only to those with permission to view. (307)
   8. Buyer: Issuing of Purchase Order (PO) and Goods Received Notes (GRN) or confirmation of sales contract fulfillment

The blockchain smart contract technology will allow a buyer to first issue a purchase Order (PO) and, subsequently, when the buyer is satisfied, a goods received note (GRN), immediately triggering a new blockchain visible to the buyer, seller and financier alike. (308)

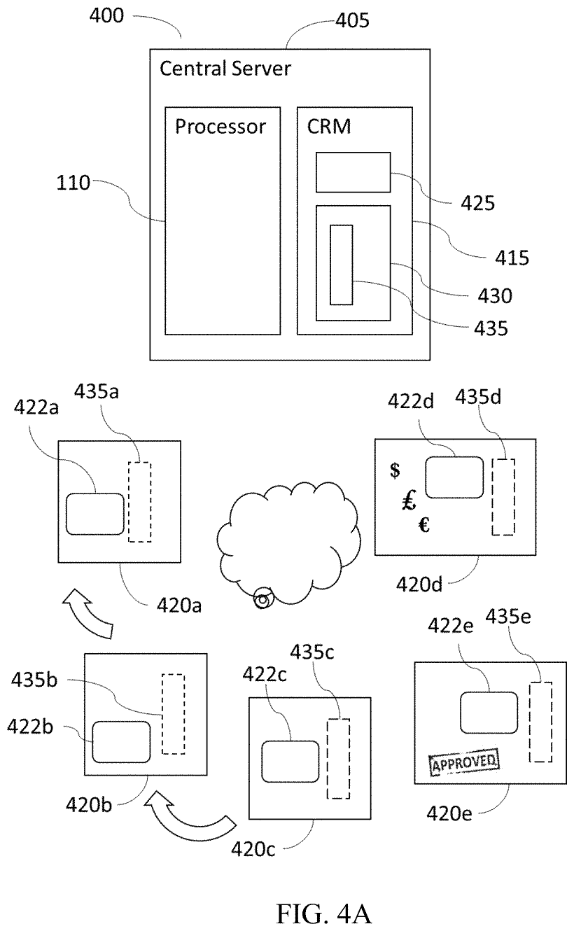

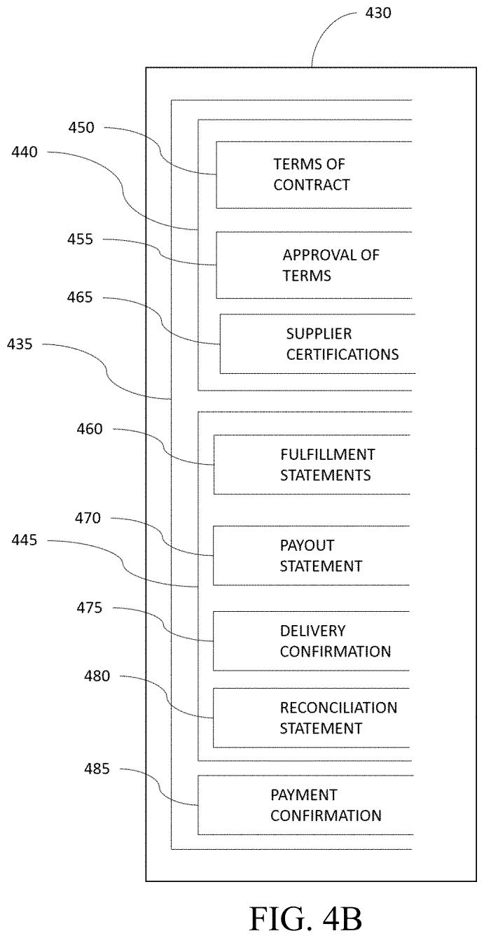

Reference is now made to FIG. 4a, showing a computer-based system 400 for implementation of multi-party, multi-tier (MPMT) contracts, according to some embodiments of the invention.

System 400 comprises a central server 405, comprised of a processor 410 and non-transitory computer readable medium (CRM) 415. CRM 415 stores a contract database 430. Contract database 430 contains contract blockchains 435, each block with a digital signature to verify legitimacy of its source, and each block encrypted in accordance with access rights to which each of client computers 420a-e is entitled. Each contract blockchain 435 stores and provides a reference for transactions in an MPMT contract.

System 400 further comprises client computers 420a-d. Client computers 420a-d include computers of an end buyer 420a, of one or more suppliers 420b-c in a supply chain, and of a financier 420d. In some embodiments, the client computers include computers of one or more certification authorities 420e.

It is understood that a “client computer” can refer to a cyber-account of a client to which more than one computing device may access with proper access validation.

Client computers 420a-d are in communicative connection with central server 405. In some embodiments, one or more groups of client computers 420a-d are in communicative connection with each other. Each supplier computer 420b-c has access to viewing contract blockchain 435 on displays 422b-c of supplier computers 420b-c. Access may be achieved by real-time, on-line reading of contract blockchain 435 on central server 405. Alternatively, each supplier computer 420b-c stores a copy 435b-c of contract blockchain 435. Copies 435b-c may be synchronized with central computer 405—for example, as a shared ledger—after each activity in the MPMT contract. In some embodiments, buyer computer 420a, financier computer 420d, and/or certifying authority computer(s) 420e have some access rights to contract blockchain 435.

Reference is now also made to FIG. 4b, showing the structure of contract blockchain 435 stored in contract database 430, according to some embodiments of the invention.

When an end buyer places an order for finished goods in exchange for an end-buyer price, a virtual purchase order (VPO) 440, including a digital signature of the end buyer, issues from computer 420a of end buyer to central server 405.

Upon receiving VPO 440, central server 405 creates contract blockchain 435 in said contract database 430. Central server appends VPO 140 to contract blockchain 435.

Central server 405 appends terms of contract 450 to VPO 440. Terms of contract 450 include the end-buyer price, fulfillment requirements for suppliers in a supply chain who will contribute toward providing the finished goods. Terms of contract 450 may be based on standing orders by suppliers and/or on agreements made between two or more suppliers for a particular MPMT contract.

Information is appended to contract blockchain 435—including to a nested layer therein such as VPO 440—is in the form of a block. New blocks may be attached only to a most recent block. Blocks may be encrypted to prevent attachment of a block by an unauthorized entity and/or to protect privacy. However, contract blockchain 435 is accessible and viewable by suppliers' computers 420c-d, and VPO 440 (and other items appended to contract blockchain 435 as described herein).

In some embodiments, VPO 440, including terms of contract 450, is issued to suppliers by synchronization of contract blockchain 435 on central server 405 with copies of contract blockchain 435a-e on client computers 420a-e. Synchronization may be initiated by central server 405, either upon appending VPO 440 or at regular time intervals.

After receiving VPO 440, suppliers issue approval of terms 455. In some embodiments, approval of terms 455, with digital signature, is communicated from each of suppliers' computers 420b-c to central server 405. Central server 405 appends approval of terms 455 to VPO 440. Alternatively, in a shared ledger implementation, suppliers' computers 420b-c attach approval of terms 455, with digital signature, to contract blockchain copies 435b-c. Synchronization is then made from contract blockchain copies 435b-c on suppliers' computers 420b-c with contract blockchain 435 on central server 405. Synchronization of blockchain copies 435a-e to other suppliers' computers 420b-c is made either simultaneously with central server 405, or later by central server 405. In all cases, contract blockchain 435 is accessible to suppliers' computers 420b-c, and VPO is visible on displays 420b-c.

In preferred embodiments, supplier certifications 465, with digital signatures of suppliers and one or more certifying authorities are appended to VPO 440, also at the prerogative of the suppliers. Certifications can include, for example, certification of land ownership, a certification of environmental standards compliance, a certification of labor laws compliance, a product certification, an ISO certification, a certification of insurance, a certification of inspection, and any combination thereof. Central server 405 may authenticate the validity of supplier certification 465 with computer 420e of certification authority.

Universal visibility of VPO 440 on each supplier computer 420b-c affords new levels of transparency to a supply chain, as all suppliers can see the VPO 440, including the initial order, all suppliers' terms of contract 450, all suppliers' approval of terms 455, and all supplier certifications 465. Furthermore, the need to initiate and process a single purchase order offers new levels of efficiency to supply chains.

Central server 405 appends a virtual invoice (VI) 445 to contract blockchain; e.g. after approval of terms 455 from each of the suppliers' computers 420b-c have been received and appended to VPO 440.

Statements of fulfillment 460, with digital signatures, are appended to VI 445 upon each supplier's fulfillment of terms of contract 450. Statements of fulfillment 460 of a supplier may be issued, based in whole or in part, by acceptance of the supplier's goods by a next-lowest supplier in the supply chain (i.e., the next-lowest supplier receives goods from the supplier). Statements of fulfillment 460 may be issued, based in whole or in part, upon receiving a report of delivery to the next-lowest supplier (e.g., from a shipping company's package-tracking website) or fulfillment of contract terms.

After appending of each statement of fulfillment 460 for each supplier, financier computer 420d is notified, either by reading of contract blockchain 435 by financier computer 420d (if permission for reading contract blockchain 435 is granted to financier computer 420d) or by a communication from central server 405 to financier computer 420d. Financier computer 420d initiates a payment to the supplier, according to the proportions specified in terms of contract 450. After payment is made, financier computer 420d initiates appending of a statement of payout 470 to VI 445, either by writing to contract blockchain 435 (if permission for writing to contract blockchain 435 is granted to financier computer 420d) or by a communication from financier computer 420d to central server 405 and subsequent appending of payout statement 470 to VI 445 by central server 405.

After the finished goods are received by the end buyer or fulfillment of contract terms is confirmed, a delivery confirmation 475 is issued, and received by central server 405. Delivery confirmation 475 is appended to VI 445. Delivery confirmation 475 may be issued and appended by central server 405 upon a report of delivery (e.g., by tie-in to a shipping company's package-tracking web site).

In preferred embodiments, central server 405 reconciles terms-of-contract 450 in VPO 440 with statements of fulfillment 460 in VI 445. A reconciliation statement 480 is added to VI 445. Reconciliation statement 480 confirms that suppliers have met terms-of-contract and the end buyer received the finished goods.

End-buyer computer 420a initiates a payment for goods received to the financier. Payment may be registered by financier computer 420d. Alternatively, financier computer 420d automatically charges the payment to a bank account of the end buyer. Financier computer 420d initiates appending of a payment confirmation 485 to contract blockchain 435, either by writing to contract blockchain 435 (if permission for writing to contract blockchain 435 is granted to financier computer 420d) or by a communication from financier computer 420d to central server 405 and subsequent appending of payment confirmation 485 to contract blockchain 435 by central server 405.

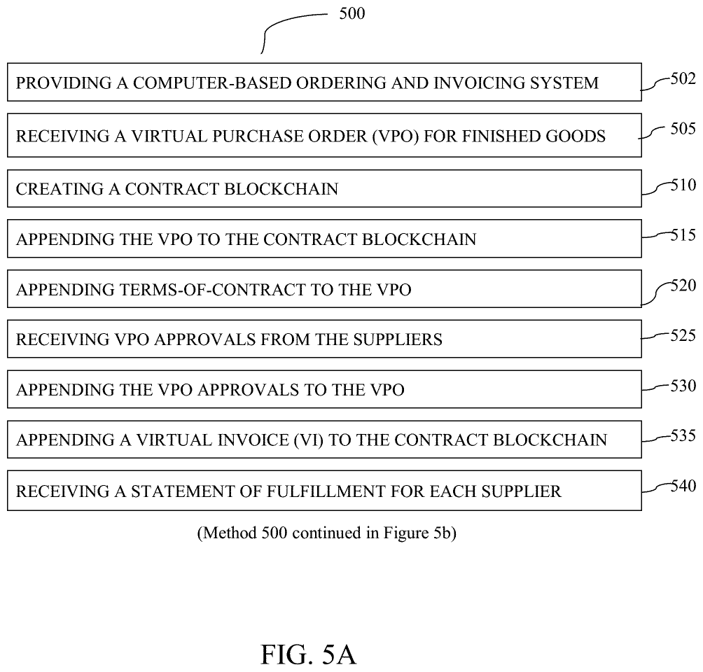

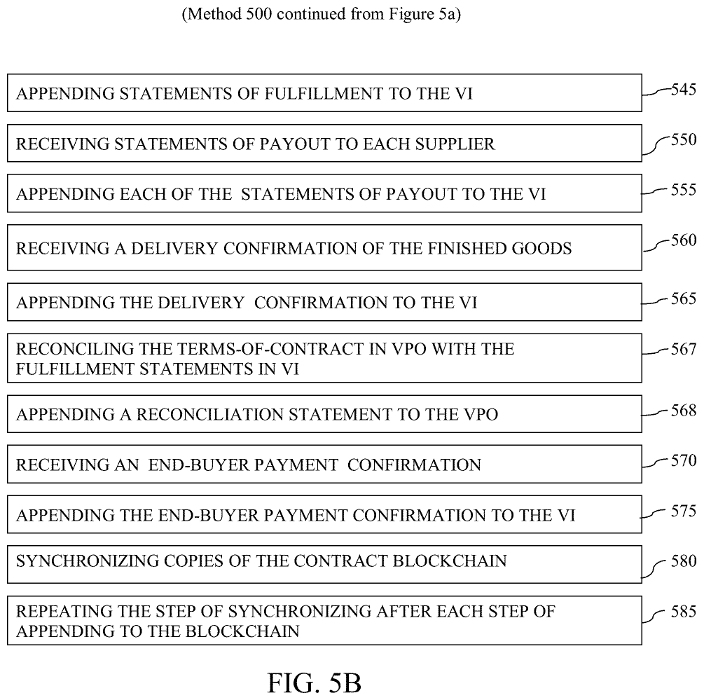

Reference is now made to FIGS. 5a and 5b, showing a showing a computer-based method 500 for implementation of multi-party, multi-tier (MPMT) contracts, according to some embodiments of the invention.

Method 500 comprises steps of
a. providing a computer-based system for ordering and invoicing among a plurality of entities with a single virtual purchase order (VPO) and single virtual invoice (VI) 502;
b. receiving, by a central server, a VPO with a digital signature, issued by an end buyer in a supply chain, for finished goods in exchange for an end-buyer price 505;
c. creating a contract blockchain in a non-transitory computer readable medium (CRM) of the central server 510;
d. appending the VPO to the contract blockchain 515;
e. appending terms-of-contract to the VPO, the terms-of-contract comprising the end-buyer price, fulfillment requirements for each supplier in the supply chain, and proportions of the end-buyer price accruing to each of the suppliers 520;
f. receiving VPO approvals with digital signatures from the suppliers 525;
g. appending the VPO approvals to the VPO 530;
h. appending a VI to the contract blockchain 535;
i. receiving a statement of fulfillment for each of the suppliers upon fulfillment of the terms-of-contract by the supplier 540;
j. appending each statement of fulfillment to the VI 545;
k. receiving a statement of payout, to each said supplier according to the proportion, from a financier upon each statement of fulfillment 550;
l. appending each receipt of payout to the VI 555;
m. receiving a delivery confirmation upon delivery of the finished goods to the end buyer or fulfillment of the terms of said-terms of-contract between buyer and seller 560 560;
n. appending the delivery confirmation to the VI 565;
o. reconciling the terms-of-contract in VPO with the fulfillment statements in VI 567;
p. appending a reconciliation statement to the contract blockchain 568;
q. receiving an end-buyer payment receipt from the financier, upon payment of the end-buyer price by the end buyer 570; and
r. appending the end-buyer payment receipt to the VI 575;
   wherein the method 500 further comprises steps of synchronizing copies of the contract blockchain on said suppliers' computers 580 and repeating the step 580 of synchronizing after each said step of appending to said blockchain 585; an updated copy of the VPO and the VI are thereby visible in on displays of the suppliers' computers.

Another aspect of the invention relates to a decentralized supply chain finance savings algorithm (DSCFS-A). DSCFS-A may be employed to establish and operate a decentralized supply chain finance savings redistribution system (DSCFS-RS). The DSCFS-RS enables buyers, sellers and financiers to employ a supply chain financing structure in which the finance savings accrued by a seller can be immutably quantified and redistributed to alternative beneficiaries. The DSCFS-A allows the users to collaboratively create and automatically implement smart contracts which autonomously and immutably quantify, and facilitate the agreed redistribution of the accrued finance savings.

In some embodiments, the DSCFS-A requires data inputs from all users to unanimously configure the DSCFS-RS smart contract(s) for the chosen supply chain (and transaction(s)). These can consist of data relating to contract terms from the buyer, seller and financier(s); and/or a purchase order from the buyer, and/or a copy of the purchase order from the seller.

Once configured, the DSCFS-A automatically deploys the smart contracts (on a distributed ledger) to autonomously (and immutably) perform the finance saving quantification and redistribution facilitation. The data inputs and outputs of the smart contract(s) can be encrypted in order to maintain security over the users' sensitive data in a distributed ledger.

The DSCFS-RS is configured for integrated operation with an ethical scoring system (further described herein) to allow for the use of distribution instructions of the DSCFS-RS to construct an ethical incentive system to encourage further ethical development in a buyer's supply chain.

The algorithm can instruct the smart contracts. The algorithm itself may be off-chain and may not store immutable data. Rather, it builds and co-ordinates the immutable smart contracts.

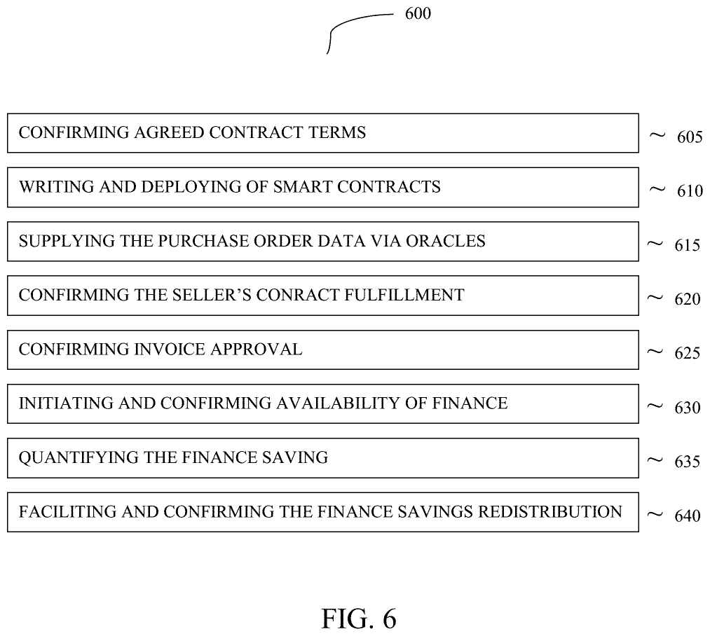

Reference is now made to FIG. 6, showing steps of the DSCFS-A method. In its various embodiments, DSCFS-A may perform one or more of the following eight steps (a-h):
a. Confirming consensus of agreed contract terms between the parties 605, in order to ensure unanimous agreement on the operations to be performed by the DSCFS-RS. Via user interfaces, all users specify the intended supply chain financing and finance saving redistribution structures to be managed by the algorithm. The specifications will be matched by the algorithm (or immutably by pre-configured smart contract) to confirm user consensus—for example, a three way match between invoice, goods received note, and purchase order. These would include data relating to the contract fulfillment conditions, payment terms, and/or distribution instructions.
b. Writing and deploying smart contract(s) to autonomously govern the supply chain financing and finance saving redistribution structures according to the confirmed specifications 610. For deployment on public ledgers, users may require that the algorithm encrypts the smart contract(s) specifications. Once deployed, all further data will be supplied to the smart contract(s) via oracle(s), appropriately encrypted if required.
c. Supplying data of the purchase order (PO), which may be a VPO (further described herein), via oracle(s), to be immutably matched by the smart contract(s) 615. Via the user interface the buyer uploads the PO to a database accessed by the algorithm. After receiving the PO from the buyer, the seller also uploads their copy of the PO to the database via their user interface. Upon receipt of both copies of the PO, the algorithm then supplies the (encrypted) data via oracles to the smart contract(s) for immutable PO data matching. DSCFS-A utilizes data from the PO such as a purchase order identifier, purchase order date, seller identifier, product identifier(s), currency, price(s), and/or quantiti(es) of product.
d. Confirming contract fulfillment of sellers 620. The confirmation is provided by the buyer via their user interface to the DSCFS-A. The algorithm will supply this data via oracle to the smart contract(s) for immutable recording. Depending on the agreed contract fulfillment specifications, this data could relate to validated forms of a goods received note, sample approval(s), acceptance signature(s).
e. Confirming approval of invoices 625. Subject to the specified contract terms, the invoice generation, issuance and approval could be automatically and immutably performed by the smart contract(s) on behalf of the buyer and seller. Alternatively, confirmation of manual issuance and approval could be provided to the algorithm by the seller and buyer via their user interfaces respectively. Data relating to the manually issued and approved invoices could then be sent via oracle(s) to the smart contract(s) for immutable recording of approval confirmation.
f. Initiating, subject to the contract terms, and confirming the availability of finance 630. The DSCFS-RS automatically provides the approved invoice to the buyer's financier for discounting and subsequently takes receipt of discount confirmation from the financier via their user interface. This could be performed immutably by smart contract(s). If the contract terms stipulate manual provision of the approved invoice by the buyer to the financier, then the algorithm awaits receipt of discounting confirmation from the financier. Data relating to the confirmation of invoice discounting could then be sent via oracle(s) to the smart contract(s) for immutable recording.
g. Quantifying the finance saving to be accrued by the supplier from the use of the supply chain financing facility 635. The quantification calculation could be performed immutably by smart contract(s), coordinated via oracle(s) by the algorithm.
h. Facilitation (i.e., giving distribution instructions to trusted third parties) and confirmation of the finance saving redistribution 640. The DSCFS-A provides immutably sourced finance saving quantification data and redistribution instructions subject to the specified contract terms to the supplier via their user interface. The supplier receives information relating to the finance saving and agreed distribution instructions and, accordingly, acts upon their contractual obligation to fulfil the redistribution instructions agreed by all parties. Any specified beneficiary(s) provides the DSCFS-RS with confirmation of receipt of the agreed redistributive payment(s) via a user interface. The algorithm supplies data relating to the confirmation of receipt via oracle(s) to the smart contract(s) for immutable recording.

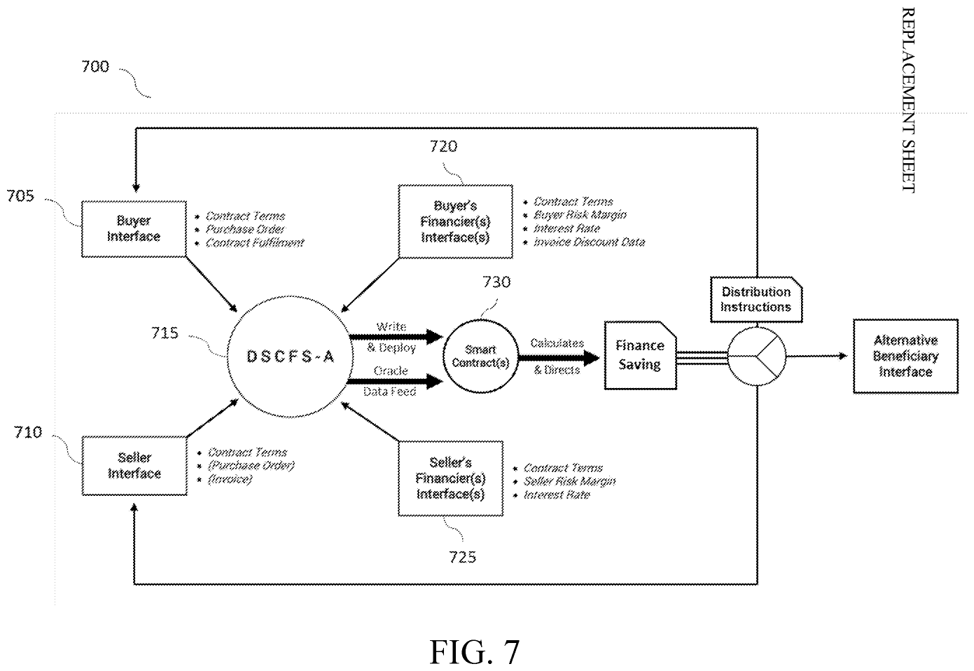

Reference is now made to FIG. 7, showing a system 700 for redistributing finance savings of a decentralized supply chain (DSCFS). System 700 comprises
o. a DSCFS server 715, configured to execute a decentralized supply chain finance savings algorithm (DSCFS-A);
p. a buyer interface 705, configured for buyer entry and sending to the DSCFS server 715 of buyer contract terms, a purchase order, and contract fulfillment conditions;
q. a seller interface 710, configured for receiving said purchase order from the DSCFS server 715 and for seller acceptance of the purchase order and for entry and sending to the DSCFS server 715 of seller contract terms and an invoice;
r. a buyer financier interface 720, configured for buyer financier entry and sending to the DSCFS server 715 of buyer financier contract terms, buyer risk margin, interest rate, and invoice discount data;
s. a seller financier interface 720, configured for seller financier entry and sending to the DSCFS server 715 of seller financier contract terms, seller risk margin, and seller interest rate;
t. a distributed-ledger network 730, configured for immutably recording transactions of smart contracts;
   said DSCFS server 715 is further configured to
u. confirm consensus of agreed terms between said parties, resulting in matched smart contract specifications in said;
v. write and deploy one or more smart contracts, immutably recorded in said distributed-ledger network 730; said smart contracts configured to autonomously govern the supply chain and redistribution of the finance savings, in accordance with said matched specifications;
w. supply data of purchase orders via oracles, said purchase order data immutably matched in said distributed-ledger network 730;
x. confirm contract fulfillment of said terms by sellers, said fulfillment immutably recorded in said distributed-ledger network 730;
y. confirm approval of invoices and immutably recording said invoice approval confirmations in said distributed-ledger network 730;
z. initiate and confirm availability of the supply chain financing facility, immutably recording data related to confirmation of invoice discounting in the distributed-ledger network 730; and
aa. quantify the finance savings to be accrued by the supplier from the use of the supply chain financing facility, said quantification immutably recorded in said distributed-ledger network 730; and
bb. facilitate and confirm the finance savings redistribution, recording said redistribution immutably in said distributed-ledger network 730.

1. A computer-based system implementing a smart contract for ordering and invoicing among a plurality of entities—comprising an end buyer, suppliers in a supply chain, and a financier—with a single virtual purchase order (VPO) and a single virtual invoice (VI), said system comprising
a. a central server comprising a processor and non-transitory computer readable medium (CRM);
b. client computers comprising computers of an end buyer, of one or more suppliers in a supply chain, and of a financier; said client computers in communicative connection with said central server;
c. said system is configured to store in said CRM
i. instructions to said processor; and
ii. a contract database configured to store one or more contract blockchains; each said contract blockchain implementing a smart contract of said supply chain;
d. said instructions cause said processor to
i. receive a VPO with a digital signature, issued by the end buyer computer, for finished goods in exchange for an end-buyer price;
ii. create a contract blockchain in said contract database;
iii. append said VPO to said contract blockchain;
iv. append terms-of-contract to said VPO, said terms-of-contract comprising said end-buyer price, fulfillment requirements for each of said suppliers, and proportions of the end-buyer price accruing to each of the suppliers;
v. receive VPO approvals with digital signatures from said supplier computers;
vi. append the VPO approvals to the VPO;
vii. appending a VI to said contract blockchain;
viii. receive a statement of fulfillment with digital signature from each of said supplier computers upon fulfillment of said terms-of-contract by each said supplier;
ix. append the statement of fulfillment to said VI, for each of said suppliers;
x. receive a statement of payout to each said supplier according to said proportion, from the financier computer;
xi. append each said statement of payout to said VI;
xii. receive a delivery confirmation upon delivery of said finished goods to said end buyer;
xiii. append said delivery confirmation to said VI;
xiv. reconcile said terms-of-contract in said VPO with said fulfillment statements in said VI;
xv. append a reconciliation statement to said VI;
xvi. receive an end-buyer payment confirmation from the financier computer, upon payment of said end-buyer price by said end buyer; and
xvii. append said end-buyer payment confirmation to said contract blockchain;
wherein said system is configured to synchronize a copy of said contract blockchain on each said suppliers' computers after each said step of appending to said contract blockchain; an updated copy of said VPO and said VI are thereby visible on displays of said suppliers' computers.

2. The system of claim 1, wherein said processor is further configured to calculate said end-buyer price and/or said proportions to each supplier as a function of one or more scores of one or more of said parties in the supply chain.

3. The system of claim 1, wherein said statement of fulfillment for each supplier is issued from a said client computer of a said supplier that is next lowest to said supplier in said supply chain.

4. The system of claim 1, wherein said instructions are further configured to cause said processor to receive one or more supplier certifications from one or more of said supplier computers and to append said supplier certifications to said VPO.

5. The system of claim 4, wherein said supplier certifications are in a group consisting of a certification of land ownership, a certification of labor laws compliance, a certification of environmental standards compliance, a product certification, an ISO certification, a certification of insurance, certification of inspection, and any combination thereof.

6. The system of claim 4, wherein said instructions are further configured to cause said processor to receive confirmations of said supplier certifications from a computer of one or more certifying authorities and to append said certification confirmations to said contract blockchain.

7. The system of claim 1, wherein said wherein said instructions are further configured to cause said processor to receive one or more transit status reports and to append said transit status reports to said VI.

8. The system of claim 7, wherein said transit status reports are issued by a client computer of an entity in a group comprising a shipping company, a customs authority, an inspection agency, a warehouse, a freight forwarder, any other transport provider (such as an airline, a road or rail transport provider), a third party verifier of goods delivery or contract fulfillment, or any combination thereof.

9. The system of claim 1, wherein said contract blockchain is accessible by computer of said buyer, of said financier, of said certifying authority, or any combination thereof.

10. A computer implemented method for facilitating financing of goods distributed to a buyer from a supplier, in a network based private or public permissioned blockchain, comprising:
a. creating an instance of an electronic cash for goods blockchain contract
b. presenting a blockchain certification for said instance
c. validating said blockchain certificate by comparing said certificate's details to said goods' details and predetermined ethical rules compliance
d. exposing said goods' details by said certificate's details
e. confirming an invoice, purchase order (PO) and goods received notes (GRN) and details according to said goods blockchain contract
f. determining rewarding extent threshold according to said ethical rules compliance
g. transferring said rewarding extent money as e-cash from said buyer to said supplier
h. sending e-docs to said buyer related to said goods blockchain contract's details
i. delivering said goods to said buyer
wherein said goods blockchain contract's details are displayed on a computer interface by a displaying module

11. The method of claim 10, wherein said providing a blockchain certification, is managed by an execution of a registration module configured to:
a. receive a request from a potential buyer to register with said certificate associated to blockchain certification
b. providing a said created blockchain certification to said buyer
c. notifying said buyer upon creation of new blockchain certification

12. The method of claim 11, wherein said validating said blockchain certificate, is managed by an execution of a comparison module.

13. The method of claim 10, wherein said certificate's details comprise any of the following attributes: geo-tagging location of said goods, time and date of transportation of said goods, third party confirmation of fulfillment of contract terms, ethical details related to compliance of ethical rules and any combination thereof.

14. The method according to claim 12, wherein said comparison module is configured to:
a. select invoices from a group associated with said goods blockchain contract's details;
b. compare a plurality of tags's records with said stored records in said database related to each said goods blockchain resulting in a satisfied or unsatisfied output and determining the supplier's ethical rating (which in turn will determine the price of the financing); and
c. displaying said output in said interface.

15. The method according to claim 10, wherein said confirming of the invoice, purchase order and goods received notes is managed by an execution of a confirmation module configured to:
a. receive a request from a potential buyer to register with said certificate;
b. compare said certificate's details with said invoice, said PO and said GRN resulting in a match vector comprising 3 attributes: a first match ranging from 0% to 100% representing a match between said certificate's details and details of said invoice in said contract details, a second match ranging from 0% to 100% representing a match between said certificate's details and details of said PO in said contract details, and a third match ranging from 0% to 100% representing a match between said certificate's details and details of said GRN in said contract details; and
c. displaying said matched vector on buyer's interface.

16. The method according to claim 10, wherein said determining rewarding extent threshold according to said ethical rules compliance is managed by an execution of determination module configured to:
a. extract said first matched attribute and said second matched attribute from said match vector; and
b. transform said first match and said second match into a unified sum of said match and said second match by means of e-cash reward value.

17. The method according to claim 10, wherein said transferring said rewarding extent money as e-cash to supplier is conducted by an execution of e-cash transaction module configured to:
a. communicate with supplier's bank account through buyer's device;
b. transmit said e-cash reward to said supplier's bank account; and
c. notify said supplier upon e-cash transmission on said supplier's device's interface.

18. The method according to claim 10, wherein said sending e-docs to buyer is conducted by an execution of a sending module configured to:
a. create e-docs consisting said certificate's details;
b. communicate with buyer's interface;
c. transmit said e-docs to said buyer's storage; and
d. notify said buyer upon transmission on said buyer's interface.

19. The method according to claim 10, wherein said delivering goods to the buyer is managed by a selection of one or more delivery transportation vehicle comprising: land, sea, and air transportation vehicle; or through third party confirmation of fulfillment of contract terms.

20. A system for redistributing finance savings of a decentralized supply chain (DSCFS), comprising
a. a DSCFS server, configured to execute a decentralized supply chain finance savings algorithm (DSCFS-A);
b. a buyer interface, configured for buyer entry and sending to said DSCFS server of buyer contract terms, a purchase order, and contract fulfillment conditions;
c. a seller interface, configured for receiving said purchase order from said DSCFS server and for seller acceptance of said purchase order and for entry and sending to said DSCFS server of seller contract terms and an invoice;
d. a buyer financier interface, configured for buyer financier entry and sending to said DSCFS server of buyer financier contract terms, buyer risk margin, buyer interest rate, and invoice discount data;
e. a seller financier interface, configured for seller financier entry and sending to the DSCFS server of seller financier contract terms, seller risk margin, and seller interest rate;
f. a distributed-ledger network, configured for immutably recording transactions of smart contracts;
said DSCFS server is further configured to
g. confirm consensus of agreed terms between said parties, resulting in matched smart contract specifications in said;
h. write and deploy one or more smart contracts, immutably recorded in said distributed-ledger network; said smart contracts configured to autonomously govern the supply chain and redistribution of the finance savings, in accordance with said matched specifications;
i. supply data of purchase orders via oracles, said purchase order data immutably matched in said distributed-ledger network;
j. confirm contract fulfillment of said terms by sellers, said fulfillment immutably recorded in said distributed-ledger network;
k. confirm approval of invoices and immutably recording said invoice approval confirmations in said distributed-ledger network;
wherein said DSCFS server is further configured to
l. initiate and confirm availability of the supply chain financing facility, immutably recording data related to confirmation of invoice discounting in said distributed-ledger network; and
m. quantify the finance savings to be accrued by the supplier from the use of the supply chain financing facility, said quantification immutably recorded in said distributed-ledger network; and
n. facilitate and confirm the finance savings redistribution, recording said redistribution immutably in said distributed-ledger network.
